(19) United States
(12) Patent Application Publication
(10) Pub. No.: US 2026/0351920 A1
(43) Pub. Date: Nov. 5, 2026

(54) METHOD FOR THE AMPLIFICATION OF A FORWARD-RUNNING LASER PULSE AND THE LOWER AMPLIFICATION OF A BACKWARD-RUNNING LASER PULSE

(71) Applicant: TRUMPF Lasersystems for Semiconductor Manufacturing SE, Ditzingen (DE)

(72) Inventors: Felix Köttig, Stuttgart (DE); Andreas Herdt, Langgöns-Niederkleen (DE)

(21) Appl. No.: 19/710,427

(22) Filed: Jun. 17, 2026

Related U.S. Application Data
(63) Continuation of application No. PCT/EP2024/083875, filed on Nov. 28, 2024.

(30) Foreign Application Priority Data
Dec. 21, 2023 (DE) 10 2023 136 334.4

(51) Int. Cl. H01S 3/097; H01S 3/223; H05G 2/00

(52) U.S. Cl. CPC H01S 3/09702; H01S 3/2232; H05G 2/00

(57) ABSTRACT

A method for amplification of a forward-running laser pulse and lower amplification of a backward-running laser pulse is provided. The forward-running laser pulse and the backward-running laser pulse pass through a laser amplifier. The method includes A) switching on or increasing a pump power provided by a pump source for the laser amplifier before the forward-running laser pulse passes therethrough, and switching off or reducing the pump power provided by the pump source for the laser amplifier before the backward-running laser pulse passes therethrough, and/or B) operating the laser amplifier with a high small-signal amplification and/or a low saturation power so that the forward-running laser pulse reduces population inversion of the laser amplifier for the backward-running laser pulse.

### CROSS REFERENCE TO RELATED APPLICATIONS

This application is a continuation of International Application No. PCT/EP2024/083875 (WO 2025/131605 A1), filed on Nov. 28, 2024, and claims benefit to German Patent Application No. DE 10 2023 136 334.4, filed on Dec. 21, 2023. The aforementioned applications are hereby incorporated by reference herein.

### FIELD

Embodiments of the present invention relate to a method for the amplification of a laser pulse.

### BACKGROUND

It is known to amplify a laser pulse in a laser amplifier. The reflections of such an amplified laser pulse at a target are problematic, since the reflected laser pulse is also amplified again in the laser amplifier and can damage a laser source of the laser pulse. Therefore, attempts are typically made to block such reflected laser pulses or to divert them before the laser source. However, a certain proportion of reflected laser radiation with comparatively high power often remains.

### SUMMARY

Embodiments of the present invention provide a method for amplification of a forward-running laser pulse and lower amplification of a backward-running laser pulse. The forward-running laser pulse and the backward-running laser pulse pass through a laser amplifier. The method includes A) switching on or increasing a pump power provided by a pump source for the laser amplifier before the forward-running laser pulse passes therethrough, and switching off or reducing the pump power provided by the pump source for the laser amplifier before the backward-running laser pulse passes therethrough, and/or B) operating the laser amplifier with a high small-signal amplification and/or a low saturation power so that the forward-running laser pulse reduces population inversion of the laser amplifier for the backward-running laser pulse.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of a laser arrangement with a laser amplifier for carrying out the method according to some embodiments;

FIG. 2 shows Frantz-Nodvik amplification curves for various small-signal amplifications and saturation powers according to some embodiments;

FIG. 3a shows an input pulse and amplified pulse in the forward direction according to some embodiments;

FIG. 3b shows the effective amplification along the laser amplifier before and after the forward-running laser pulse passes through according to some embodiments;

FIG. 4a shows the output power, i.e., amplified power, of a laser amplifier after the forward-running laser pulse passes through according to small-signal amplification and saturation power, normalized to the input power, according to some embodiments;

FIG. 4b shows the effective amplification of a laser amplifier, integrated along the laser amplifier, after the forward-running laser pulse passes through according to small-signal amplification and saturation power, according to some embodiments; and

FIG. 4c shows the amplification of a backward-running laser pulse after a forward-running laser pulse passes through according to small-signal amplification and saturation power, wherein it is assumed that the input power of the backward-running laser pulse is equal to the input power of the forward-running laser pulse, according to some embodiments.

### DETAILED DESCRIPTION

Embodiments of the invention provide a method that protects the laser source significantly better compared to methods known from the prior art.

According to embodiments of the invention, a method for the amplification of a forward-running laser pulse and the lower amplification of a backward-running laser pulse, wherein the laser pulses pass through a laser amplifier, comprising the following method steps:
A) switching on or increasing the pump power provided by a pump source for the laser amplifier (14) before the forward-running laser pulse passes through, and switching off or reducing the pump power provided by the pump source for the laser amplifier (14) before the backward-running laser pulse passes through; and/or
B) operating the laser amplifier with such a high small-signal gain and/or such a low saturation power that the forward-running laser pulse largely reduces the population inversion of the laser amplifier for the backward-running laser pulse.

According to embodiments of the invention, the population inversion of the laser amplifier is significantly lower when the backward-running laser pulse passes through than when the forward-running laser pulse passes through. This allows both the forward-running laser pulse to be amplified more efficiently and the backward-running laser pulse to be reduced, so that the backward-running laser pulse poses less of a danger to the laser source.

The term population inversion refers to the excitation state of a laser-active medium in which it is able to generate and/or amplify laser radiation through stimulated emission.

In addition, the term small-signal amplification refers to a measure of the ability of the active laser medium to increase the intensity of laser radiation.

Furthermore, the term saturation power in this context means, in a broader sense, the absolute total amount of energy achieved by the laser-active medium in the state of population inversion. The saturation power therefore depends, on the one hand, on the pump power applied to the laser-active medium and, on the other hand, on the total amount of the laser-active medium within a certain volume. The total amount of the laser-active medium within the specified volume can be deduced, for example, from the pressure prevailing in that specific volume, provided that the laser-active medium is a gas or gas mixture.

In other words, embodiments of the invention are based on the understanding that small-signal amplification and saturation power are interdependent, in that small-signal amplification, i.e. the degree of amplification of the laser radiation, can only be increased up to a certain threshold of saturation power. In other words, once a specific value of saturation power is reached, the laser radiation cannot be significantly increased further; instead, the amplification of the laser radiation stagnates beyond this specific value of saturation power.

Methods known from the prior art do not take this circumstance into account, so the laser-active medium is substantially in a state of “supersaturation” when the forward-running pulse passes through the laser amplifier, for example due to the total amount of laser-active medium used and/or the applied pump power. Due to the limited small-signal amplification, the laser pulse passing through the laser amplifier does not absorb all of the excitation energy in the laser amplifier, but leaves a significant proportion of the population inversion in the laser-active medium. In known methods, the backward-running laser pulse is then amplified in the reverse direction by this “residual population inversion”, which can lead to damage or destruction of the laser source.

Preferably, the small-signal amplification is therefore greater than 0.14 l/m, in particular greater than 0.17 l/m, and particularly preferably greater than 0.20 l/m.

The saturation power is preferably less than 30 W, in particular less than 25 W, and particularly preferably less than 20 W.

In a particularly preferred embodiment of the invention, the laser amplifier is designed in the form of a CO₂ laser amplifier.

The laser amplifier can be pumped by HF radiation.

In method step A), the pump power can be switched on or increased for more than 1 μs and/or switched off or reduced for less than 2 μs. The pump power is preferably switched on or increased for more than 5 μs, in particular for more than 15 μs. Alternatively or additionally, the pump power is preferably switched off or reduced for less than 1 μs, in particular less than 0.5 μs.

In method step B), the small-signal amplification and/or the saturation power can be achieved by a gas pressure in a range of 80 hPa to 115 hPa, in particular 90 hPa to 110 hPa, in particular 100 hPa, and/or a pump power in a range of 4.5 kW to 7 kW, in particular 4.8 kW to 6.7 kW. A standard CO₂ laser gas with the components He, N₂, CO₂ and Xe in the ratio 3He:1N₂:1CO₂+3% Xe, or a composition optimized for the laser amplifier, can be used as a gas mixture.

The pump power is preferably less than 100%, in particular less than 80%, and particularly preferably less than 60% of the pump power at which the maximum temperature of the laser gas reaches a value of approximately 200 °C. Alternatively or additionally, the pump power is preferably less than 10 KW, in particular less than 8 kW, preferably 4.5 kW to 7 kW, more preferably 4.8 kW to 6.7 kW and particularly preferably less than 6 kW.

Similarly to the previous explanations, in method step B) the low saturation power can be achieved by reduced gas pressure and optimized pump power.

In a preferred embodiment, a low pump power is generally achieved by a short duty cycle of the pumped laser amplifier. The duty cycle is preferably less than 80%, in particular less than 70%, and particularly preferably less than 60% of a continuous duty cycle (CW mode). The pump power during the duty cycle is preferably 100% of the maximum possible pump power, in particular between 8 kW and 12 kW.

The forward-running laser pulse can comprise a plurality of partial pulses; in particular the forward-running laser pulse can consist of a plurality of partial pulses. By splitting the laser pulse into a plurality of partial pulses, EUV radiation can be generated particularly effectively. The partial pulses can have at least one main pulse and/or at least one pre-pulse.

The backward-running laser pulse can be generated by reflection of the forward-running laser pulse at a target. The target can be in the form of a tin droplet to generate EUV radiation.

Embodiments of the invention furthermore relate to a laser arrangement for carrying out a method described herein.

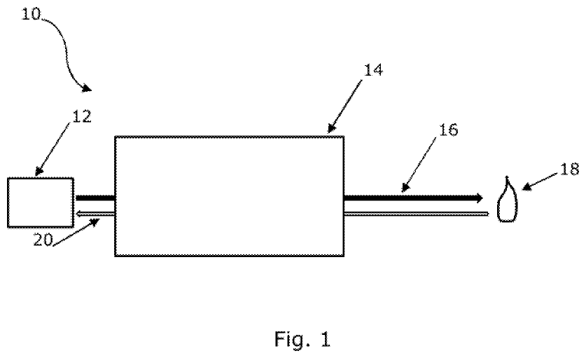

FIG. 1 shows a laser arrangement 10 with a laser source 12 and a laser amplifier 14. A forward-running laser pulse 16 is generated in the laser source 12 and amplified in the laser amplifier 14. The amplified forward-running laser pulse 16 impinges on a target 18. The target 18 can, for example, be designed in the form of a tin droplet to generate EUV radiation. A backward-running laser pulse 20 can originate from the target 18, which could damage the laser source 12.

To reduce the backward-running laser pulse 18, the pump power of the laser amplifier 14 can at least be reduced before the backward-running laser pulse passes through. Preferably, the pump power of the laser amplifier 14 is completely reduced before the backward-running laser pulse passes through.

Alternatively or additionally, the laser amplifier 14 can be operated with such a high small-signal amplification and/or such a low saturation power that—as will be explained below—the population inversion of the laser amplifier 14 by the forward-running laser pulse 16 is largely reduced.

A laser amplifier 14 amplifies incident optical radiation by stimulated emission in a laser transition between a higher energy level (excited state) and a lower energy level (ground state). By exciting (pumping) the laser-active medium, population inversion can be achieved, i.e., the particle density of the laser-active particles in the excited state is higher than that of the particles in the ground state. In this state, stimulated emission and thus amplification of an incident optical beam in the laser amplifier can be achieved. The higher the population inversion, the higher the amplification and the energy stored in the laser-active medium.

The amplification of a laser can be approximately described using the Frantz-Nodvik theory:

$${P}_{o u t} = {P}_{s a t} ln ( 1 + exp ( {G}_{0} ) ( exp ( \frac{{P}_{i n}}{{P}_{s a t}} ) - 1 ) )$$

where G₀ denotes the small-signal amplification, Pₛₐₜ denotes the saturation power, Pᵢₙ denotes the input power, and Pₒᵤₜ denotes the output power. The small-signal amplification is proportional to the population inversion of the laser-active medium and refers to the state before an incident pulse was amplified. The saturation power is inversely proportional to the cross-section of the laser transition. According to the Frantz-Nodvik theory, the following applies approximately for small input powers:

Pₒᵤₜ≈exp(G₀)Pᵢₙ

As the input power increases, the effective amplification is reduced (the energy stored in the laser-active medium is finite). For very large input powers, the following applies approximately:

Pₒᵤₜ≈Pᵢₙ+G₀Pₛₐₜ
the maximum extractable power is approximately G₀Pₛₐₜ.

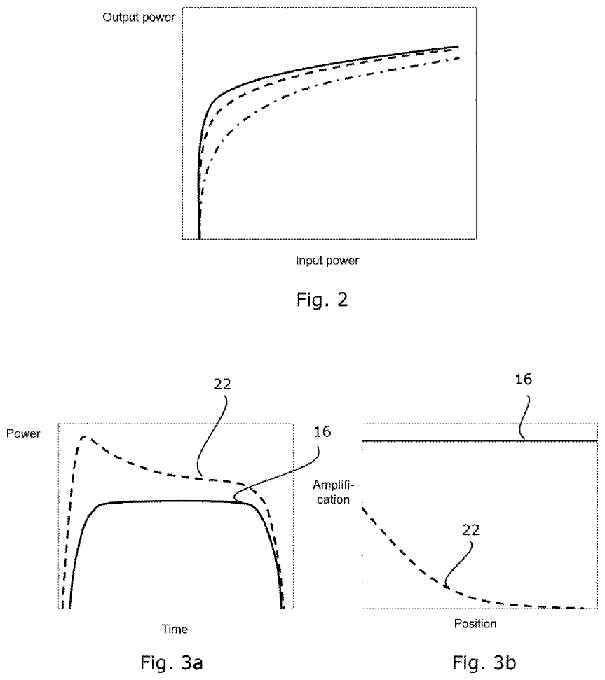

FIG. 2 shows, by way of example, the output power of a laser amplifier 14 as a function of the input power according to the Frantz-Nodvik model. For the three cases shown, G₀Pₛₐₜ=constant; however, small-signal amplification and saturation power differ. Increasing the small-signal amplification and reducing the saturation power allows for an increase in output power (given a finite input power) without increasing the energy stored in the laser amplifier 14.

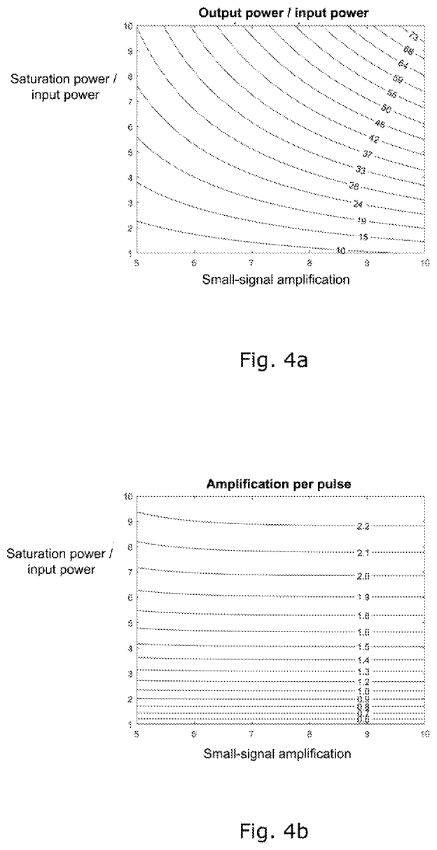

FIGS. 3a and 3b show, by way of example, the amplification of a pulse in a laser amplifier 14 according to the Frantz-Nodvik model. Before the forward-running laser pulse 16 passes through, the initial effective amplification is equal to the small-signal amplification. The amplification of the forward-running laser pulse 16 reduces the population inversion and thus the effective amplification that a subsequent backward-running laser pulse 20 experiences in the laser amplifier 14. In FIGS. 3a and 3b, the forward-running laser pulse 16 is marked with a solid line and an amplified laser pulse 22 is marked with a dashed line.

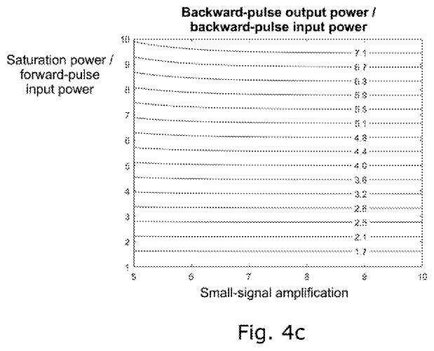

FIGS. 4a and 4b show the output power (=amplified power, normalized to the input power) of the forward-running laser pulse 16 and the effective amplification of the laser amplifier 14 (integrated along the laser amplifier) after the forward-running laser pulse 16 passes through according to small-signal amplification and saturation power (normalized to the input power). The amplification of the backward-running laser pulse 20 depends on the remaining effective amplification or “residual population inversion” after the forward-running laser pulse 16 has passed through the laser amplifier 14.

FIG. 4c shows the output power (=amplified power, normalized to the input power) of the backward-running laser pulse 20 after the forward-running laser pulse 16 has passed through the laser amplifier 14 (it is assumed by way of example that the input power of the backward-running laser pulse 20 is equal to the input power of the forward-running laser pulse 16). Optimizing small-signal amplification and saturation power for a target output power makes it possible to reduce the amplification of the backward-running laser pulse 20 by setting a correspondingly high small-signal amplification and a correspondingly low saturation power.

In a real laser amplifier 14, the amplification of the backward-running laser pulse 20 also depends on a time difference between the forward-running laser pulse 16 and the backward-running laser pulse 20 if the laser amplifier 14 continues to be pumped and the population inversion increases again after the forward-running laser pulse 16 has passed through.

In a laser amplifier 14 in the form of a CO₂ laser amplifier, the small-signal amplification and the saturation power can be set for a given geometry (length and volume of the laser amplifier). This can be achieved by adjusting the laser gas (composition and/or pressure) and by HF excitation of the laser gas. Starting from an operating point of the laser amplifier 14 known from the prior art, the small-signal amplification increases and the saturation power decreases, for example, when a gas pressure is reduced. Average HF pump power has a strong influence on saturation power; for example, a reduction in the average HF pump power reduces saturation power. At the same time, in such a case with reduced HF pump power, the small-signal amplification increases until a maximum is reached.

In summary, small-signal amplification can be increased and saturation power reduced by reducing the gas pressure and the average HF pump power (starting from the typical operating point). If the gas pressure is too low and the HF amplitude is too small, the HF discharge and thus the laser amplifier 14 become unstable. To reduce the average HF pump power, it is therefore advantageous to feed the HF pump power into the laser amplifier 14 in a pulsed mode, an amplitude being kept at a maximum, but the average HF pump power being able to be reduced via the duty cycle.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for amplification of a forward-running laser pulse and lower amplification of a backward-running laser pulse, wherein the forward-running laser pulse and the backward-running laser pulse pass through a laser amplifier, the method comprising:
A) switching on or increasing a pump power provided by a pump source for the laser amplifier before the forward-running laser pulse passes therethrough, and switching off or reducing the pump power provided by the pump source for the laser amplifier before the backward-running laser pulse passes therethrough; and/or
B) operating the laser amplifier with a high small-signal amplification and/or a low saturation power so that the forward-running laser pulse reduces population inversion of the laser amplifier for the backward-running laser pulse.

2. The method according to claim 1, wherein the laser amplifier is configured as a CO₂ laser amplifier.

3. The method according to claim 1, wherein the laser amplifier is pumped by HF radiation.

4. The method according to claim 1, wherein in the step A), the pump power is switched on or increased for more than 1 μs and/or switched off or reduced for less than 2 μs.

5. The method according to claim 1, wherein in the step B), the small-signal amplification and/or the saturation power is achieved by a gas pressure in a range of 80 hPa to 115 hPa, and/or a pump power in a range of 4.5 kW to 7 kW.

6. The method according to claim 1, wherein the forward-running laser pulse comprises a plurality of partial pulses.

7. The method according to claim 6, wherein the plurality of partial pulses has at least one main pulse and/or at least one pre-pulse.

8. The method according to claim 1, wherein the backward-running laser pulse is generated by reflection of the forward-running laser pulse at a target.

9. The method according to claim 8, wherein the target is configured in a form of a tin droplet for generating EUV radiation.
